(19) United States
(12) Patent Application Publication
(10) Pub. No.: US 2022/0081119 A1
(43) Pub. Date: Mar. 17, 2022

(54) AIR DEFLECTOR AND SYSTEM INCLUDING THE AIR DEFLECTOR

(71) Applicant: MHI RJ Aviation ULC, Boisbriand (CA)

(72) Inventors: Hongzhi Wang, Saint-Laurent (CA); Danilo Verrelli, Laval (CA); Michel Rheaume, St-Hippolyte (CA)

(73) Assignee: MHI RJ Aviation ULC, Boisbriand, (CA)

(21) Appl. No.: 17/416,894

(22) PCT Filed: Dec. 17, 2019
(86) PCT No.: PCT/CA2019/051827

§ 371 Date: Jun. 21, 2021

Related U.S. Application Data
(60) Provisional application No. 62/783,321, filed on Dec. 21, 2018.

(51) Int. Cl. B64D 13/00; B64D 11/00

(52) U.S. Cl. CPC B64D 13/00; B64D 2013/003; B64D 11/003

(57) ABSTRACT

An air deflector that includes a vane with a vane top, a vane bottom, a vane first side, and a vane second side, where the vane first side and the vane second side define a vane longitudinal axis extending therebetween and a closure with a closure top. The air deflector also includes a closure bottom, a closure first side, and a closure second side, where the closure first side and the closure second side define a closure longitudinal axis extending therebetween. The vane longitudinal axis intersects the closure longitudinal axis. The vane is disposed at a predetermined angle with respect to the closure longitudinal axis.

### CROSS-REFERENCE TO RELATED APPLICATION(S)

This International PCT Patent Application relies for priority on U.S. Provisional Patent Application Ser. No. 62/783,321 filed on Dec. 21, 2018, the entire content of which is incorporated herein by reference.

### FIELD OF THE INVENTION

The present invention concerns an air deflector and a system including the air deflector. More specifically, the present invention concerns an air deflector that may be installed in an air duct or plenum within an aircraft to redirect air flow within the aircraft cabin.

### DESCRIPTION OF THE RELATED ART

When designing an aircraft cabin, aircraft designers address a number of comfort issues for passengers including, among them, the distribution of air within the cabin.

As should be apparent to those skilled in the art, once an aircraft is placed into service, it may become necessary to adjust the air flow within the cabin of the aircraft to accommodate conditions specific to that aircraft. For example, the aircraft may have too little or too much air flow in a particular area or zone within the aircraft cabin.

As also should be apparent to those skilled in the art, air flows within an aircraft cabin though one or more air conduits and air plena. An air plenum is generally understood as an air distributor. Typically, an air plenum includes a plurality of openings through which the air flows from the air plenum into the aircraft cabin.

If it becomes desirable to alter the distribution of air within the aircraft cabin after an aircraft has been placed into service, the air conduits and air plena need to be adjusted. This is expensive and time consuming, because this adjustment may require removing one or more panels to access the relevant components concealed thereby.

The prior art fails to provide simple and effective solutions for altering air flow within an aircraft cabin.

### SUMMARY OF THE INVENTION

The present invention seeks to address one or more of the deficiencies associated with the prior art.

In particular, the present invention provides an air deflector that includes a vane with a vane top, a vane bottom, a vane first side, and a vane second side, where the vane first side and the vane second side define a vane longitudinal axis extending therebetween. The air deflector also includes a closure with a closure top, a closure bottom, a closure first side, and a closure second side, where the closure first side and the closure second side define a closure longitudinal axis extending therebetween. The vane longitudinal axis intersects the closure longitudinal axis. The vane is disposed at a predetermined angle with respect to the closure longitudinal axis.

In one contemplated embodiment, the air deflector also has a pivot connecting the vane first side to the closure first side. The pivot permits the vane to rotate with respect to the closure.

It is contemplated that the vane may include a plurality of perforations therethrough.

The closure may have a first projection extending from a closure first side and a second projection extending from a closure second side.

It is also contemplated that the closure may have a first projection extending from a closure first side and a second projection extending from a closure second side. If so, the pivot may connect the first projection to the vane first side.

In one contemplated variation, the pivot may be a ball joint that permits the vane to be angled with respect to the closure.

The present invention also provides a system for adjusting an air flow within a cabin of an aircraft. The air deflector includes an air plenum and a vent plate covering an outlet of the air plenum, where the vent plate defines a plurality of openings. At least one air deflector is disposable, within the air plenum, through one of the plurality of openings. The at least one air deflector includes a vane with a vane top side, a vane bottom side, a vane first side, and a vane second side, where the vane first side and the vane second side define a vane longitudinal axis extending therebetween. The at least one air deflector also includes a closure with a closure top side, a closure bottom side, a closure first side, and a closure second side, where the closure first side and the closure second side define a closure longitudinal axis extending therebetween. The vane longitudinal axis intersects the closure longitudinal axis. The vane is disposed at a predetermined angle with respect to the closure longitudinal axis.

In one contemplated embodiment, the at least one air deflector also has a pivot connecting the vane first side to the closure first side. The pivot permits the vane to rotate with respect to the closure.

The one of the plurality of openings is contemplated to have an opening top side, an opening bottom side, an opening first side, and an opening second side. The one of the plurality of openings is considered to define an opening length between the opening first side and the opening second side. The one of the plurality of openings also is considered to define an opening height between the opening top side and the opening bottom side. Here, the vane includes a first surface and a second surface defining a vane thickness therebetween. The vane also defines a vane height between the vane top side and the vane bottom side. The vane height is less than the opening length.

Still further, the vane thickness is contemplated to be less than the opening height.

In a further contemplated embodiment, the vane height is greater than the opening height.

The system of the present invention may be constructed so that the closure has a first protrusion extending from the closure first side and a second protrusion extending from the closure second side. Here, the first protrusion and the second protrusion define a closure height.

Alternatively, the at least one air deflector may include a pivot connecting the vane first side to the closure first side. Here, the pivot is contemplated to permit the vane to rotate with respect to the closure. Also, the pivot is contemplated to connect the first projection to the vane first side.

In an embodiment, the closure height is less than or equal to the opening height, permitting the first protrusion and the second protrusion to be insertable into at least the one of the plurality of openings.

The first protrusion may be insertable into a first of the plurality of openings and the second protrusion may be insertable into a second of the plurality of openings adjacent to the first of the plurality of openings.

In the system of the present invention, the vane may have a plurality of perforations therethrough.

Furthermore, in the system, the pivot may have a ball joint that permits the vane to be angled with respect to the closure.

The vane in the system is contemplated to have an installation configuration permitting the vane to be inserted through the one of the plurality of openings. The vane also is contemplated to have an installed configuration where the vane is rotated within the air plenum.

In the system, at least one gap may separate the vane from the air plenum.

In the system, the air plenum may include a rear wall. Here the vane may extend at least a portion of a distance from the vent plate to the rear wall.

Still further aspects of the present invention will be made apparent from the drawings and the discussion provided below.

### BRIEF DESCRIPTION OF THE DRAWINGS

The drawings illustrate various, non-limiting embodiments of the present invention, in which:

FIG. 1 is a cross-sectional view of an aircraft cabin where the system and air deflector of the present invention may be employed;

FIG. 2 perspective illustration of an overhead storage bin of the type typically found in an aircraft cabin where positions of one or more air ducts and/or air plena are shown in relation to the overhead storage bin;

FIG. 3 is a perspective illustration of another embodiment of a storage bin, showing another contemplated configuration of air ducts and air plena in relation thereto;

FIG. 4 is a perspective illustration depicting a contemplated embodiment of an air deflector according to the present invention, shown in one orientation within an air plenum;

FIG. 5 is a perspective, expanded illustration of the air deflector shown in FIG. 4;

FIG. 6 is a perspective, expanded illustration of a variation of the air deflector shown in FIG. 5; and

FIG. 7 is a graphical, top view of several air deflectors positioned within an air plenum.

### DESCRIPTION OF EMBODIMENTS OF THE INVENTION

The present invention will now be described in connection with one or more embodiments. The discussion of specific embodiments is intended to highlight the breadth and scope of the present invention without limiting the invention thereto. Those skilled in the art should appreciate that the present invention may be implemented via one or more equivalents and variations of the embodiments described herein. Those equivalents and variations are intended to be encompassed by the present invention.

In the paragraphs that follow, the present invention is described in connection with its deployment in an aircraft. While the air deflector and system of the present invention are discussed in connection with an aircraft cabin, the present invention may be employed in other environments including, but not limited to, trains, cars, boats, etc.

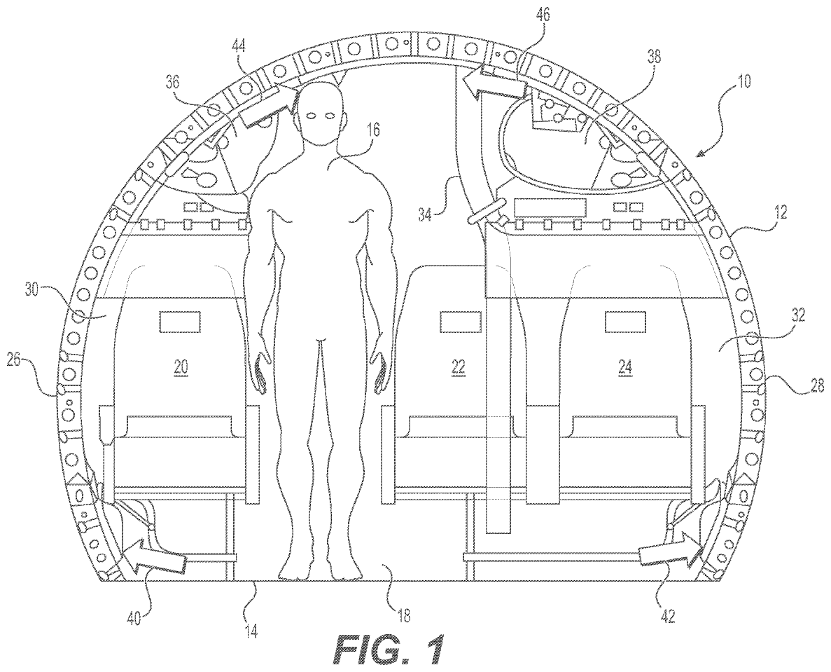

FIG. 1 is a cross-sectional view of an aircraft cabin 10. The aircraft cabin 10 is one environment where the air deflector 80, 81 of the present invention may be employed.

The aircraft cabin 10 illustrated in FIG. 1 depicts a configuration commonly employed for commercial passenger service. The aircraft cabin 10 is bounded, on the top and sides, by the fuselage 12 of the aircraft and, on the bottom, by the cabin floor 14. For scale, a passenger 16 is illustrated standing in the aisle 18 that extends along the longitudinal axis of the aircraft.

FIG. 1 also illustrates one row of passenger seats 20, 22, 24 that are secured to the floor 14. As illustrated, there is a single seat 20 on the starboard side 26 of the aisle 18 of the aircraft cabin 10 and two seats 22, 24 on the port side 28 of the aisle 18. Two bulkheads 30, 32 are shown, together with a dividing curtain 34. A starboard-side overhead bin 36 is disposed above the seat 20. Similarly, a port-side overhead bin 38 is disposed over the seats 22, 24.

As should be apparent to those skilled in the art, the illustrated aircraft cabin 10 illustrates one possible configuration for an aircraft. Other configurations are possible without departing from the scope of the present invention. For example, some commercial aircraft include seven or more passenger seats in a row. Still further, for corporate and private aircraft, the interior layout is expected to differ considerably from the illustrated configuration, because the aircraft cabin 10 may include a bedroom, sitting area, or the like. Regardless of the configuration of the aircraft cabin 10, the present invention may be employed in many different types of environments, as highlighted by the discussion that follows.

With continued reference to FIG. 1, it is noted that the air within the aircraft cabin 10 typically is circulated so that air is drawn from the aircraft cabin at positions near to the floor 14. The air intake is indicated by the arrows 40, 42. Air is re-introduced into the aircraft cabin 10 typically near to the top of the fuselage 12, from vents that are positioned above the overhead bins 36, 38. The flow of return air is designated by the arrows 44, 46. It is noted that the present invention is not limited to the illustrated configuration, but may be employed in any configuration of air intake vents and air return vents.

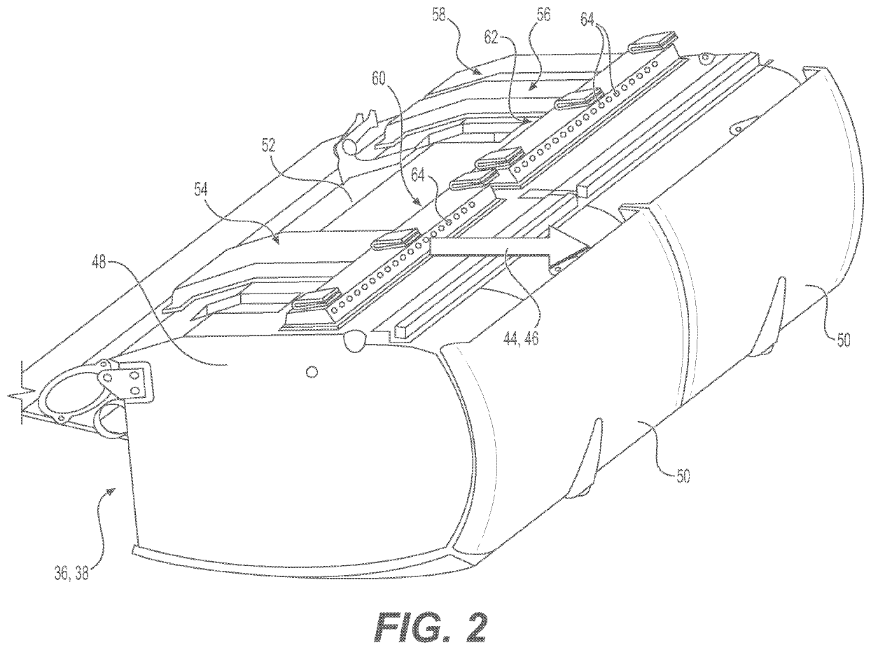

FIG. 2 is an enlarged, perspective view of a single overhead bin 36, 38. The overhead bin 36, 38 includes a housing 48 defining an interior compartment (not shown) that is accessible via doors 50. Luggage and personal items may be stored in the overhead bin 36, 38, as should be apparent to air travelers and to those skilled in the art.

The top surface 52 of the overhead bin 36, 38 is offset from the fuselage 12 by a predetermined distance, creating a gap between the overhead bin 36, 38 and the fuselage 12. Various components may be disposed in this gap. For example, in the illustrated embodiment, the top surface 52 has a number of air ducts 54, 56, 58 disposed thereon. The ducts 54, 56, 58 connect to air plena 60, 62 that also are disposed on the top surface 52 of the overhead bin 36, 38. The air plena 60, 62 include a plurality of openings 64 though with the air exits from the air plena 60, 62 into the aircraft cabin 10. The air flows in the direction of the arrows 44, 46.

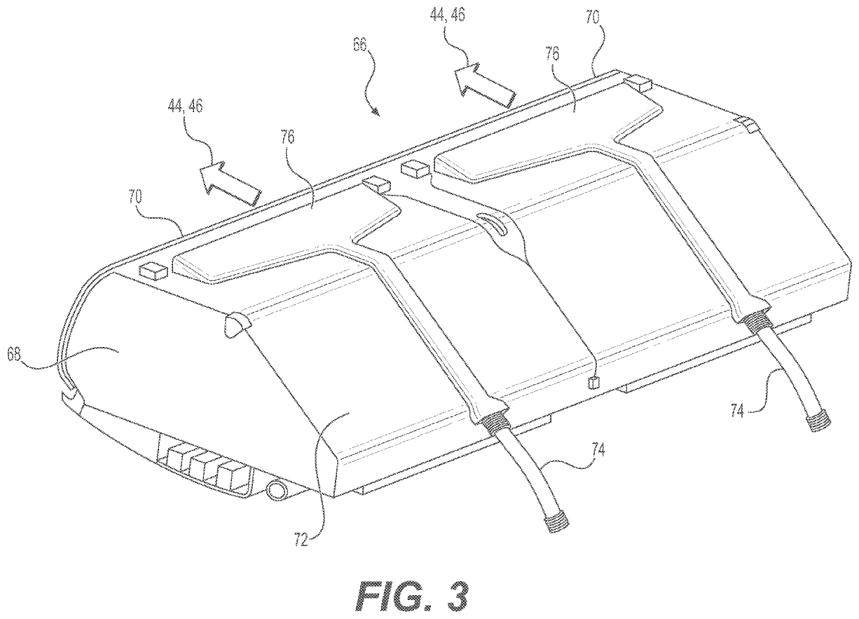

FIG. 3 is a perspective illustration of another embodiment of an overhead bin 66. Like the overhead bin 36, 38 illustrated in FIG. 2, the overhead bin 66 includes a housing 68 with doors 70 and a top surface 72. Air ducts 74 connect to an air plenum 76 disposed atop the top surface 72 of the overhead bin 66. As before, air exits from the air plenum 76 in the direction of the arrows 44, 46.

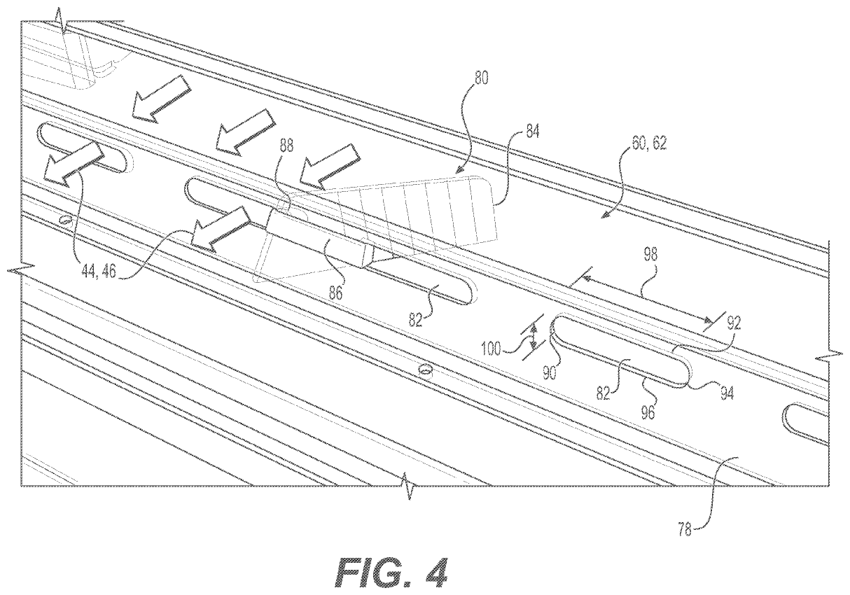

FIG. 4 is an enlarged, perspective view of a portion of the overhead bin 36, 38 illustrated in FIG. 2. Here, the view is taken from a position exterior to the air plenum 60, 62, at a point near to the interface between the overhead bin 36, 38 and the fuselage 12. A vent plate 78 covers the air plenum 60, 62. A first embodiment of a vent deflector 80 according to the present invention is disposed within the air plenum 60. 62, adjacent to two of the openings 82 in the vent plate 78.

It is noted that the openings 82 illustrated in FIG. 4 are a variation of the openings 64 shown in FIG. 2. In particular, the openings 82 are elongated holes that differ from the circular openings 64 shown in FIG. 2. It is noted that the sizes and shapes of the openings 64, 82 do not limit the present invention. However, to facilitate insertion of the air deflector 80 into the air plenum 60, 62, the elongated holes are anticipated to be employed.

In the illustrated embodiment, the air deflector 80 includes a vane 84, a closure 86, and a pivot 88. The pivot 88 connects the vane 84 to the closure 86. In the illustrated embodiment, the closure 86 extends from one opening 82 to an adjacent opening 82, partially closing (or covering) portions of each of the two adjacent openings 82. The vane 84 extends into the air plenum 62 from the pivot 88 that connects the vane 84 to the closure 86.

The air deflector 80 is designed to be installed by a technician from a position within the aircraft cabin 10, outside of the air plenum 60, 62. To install the air deflector 80 in the air plenum 60, 62, a technician first inserts the vane 84 through the opening 82. Then, the closure 86 is attached to the vent plate 78. Finally, the vane 84 is rotated within the air plenum 60, 62 to the vertical orientation illustrated in FIG. 4. Once vertically oriented within the air plenum 60, 62, the vane 84 presents a barrier that alters the air flow through the air plenum 60, 62 and, thereby, also alters the air flow through the openings 82. In this manner, the air flow within the aircraft cabin 10 is adjusted locally.

As illustrated in FIG. 4, each opening 82 has an opening first side 90, an opening top side 92, an opening second side 94, and an opening bottom side 96. Each opening 82 defines an opening length 98 that extends between the opening first side 90 and the opening second side 94. In addition, each opening 82 defines an opening height 100 that extends between the opening top side 92 and the opening bottom side 96. While the openings 82 are not restricted to any particular opening length 98 or opening height 100, the opening length 98 and opening height 100 are contemplated to be large enough to permit the vane 84 to be inserted therethrough.

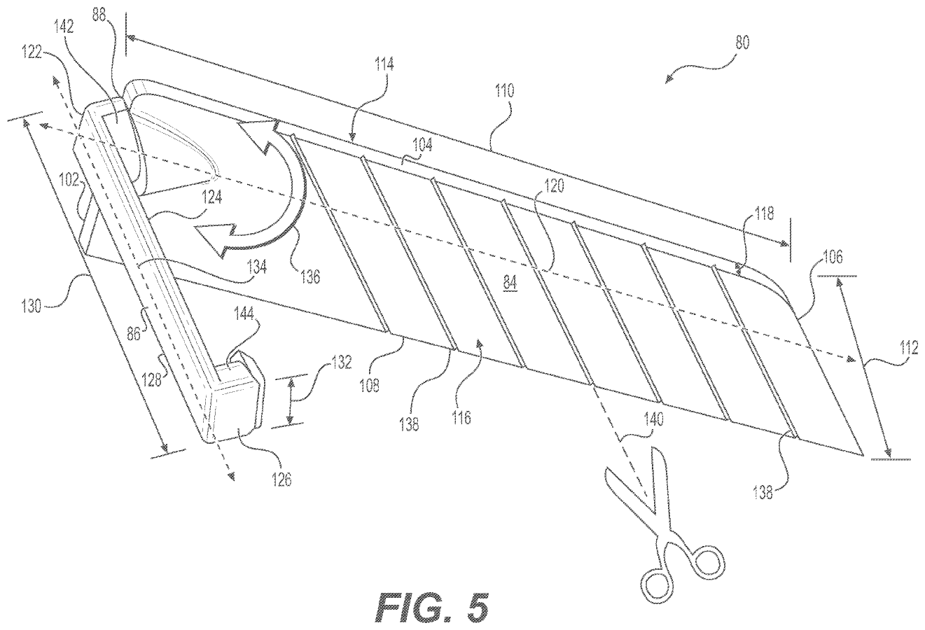

FIG. 5 is an enlarged perspective illustration of the air deflector 80 illustrated in FIG. 4.

For the air deflector 80, the vane 84 has a vane first side 102, a vane top side 104, a vane second side 106, and a vane bottom side 108. The vane 84 defines a vane length 110 that extends between the vane first side 102 and the vane second side 106. The vane 84 also defines a vane height 112 that extends between the vane top side 104 and the vane bottom side 108. In addition, the vane 84 has a vane first surface 114 and a vane second surface 116 that define a thickness 118 therebetween. The vane 84 also defines a vane longitudinal axis 120 that extends between the vane first side 102 and the vane second side 106. The vane length 110 and the vane longitudinal axis 120 are co-linear.

The closure 86 has a closure first side 122, a closure top side 124, a closure second side 126, and a closure bottom side 128. The closure 86 defines a closure length 130 that extends between the closure first side 122 and the closure second side 126. The closure 86 also defines a closure height 132 that extends between the closure top side 124 and the closure bottom side 128. The closure 86 defines a closure longitudinal axis 134 that is co-linear with the closure length 130.

FIG. 5 also shows the pivot 88 connecting the vane 84 to the closure 86 such that the vane longitudinal axis 120 intersects with the closure longitudinal axis 134. The pivot 88 permits the vane 84 to rotate with respect to the closure 86, as indicated by the arrow 136. When the air deflector is in an installation configuration, the vane 84 is co-planar with the closure 86. Then the vane 84 is oriented to that it is perpendicular to the closure 86, the air deflector is in the installed configuration.

In the embodiment illustrated in FIG. 5, the pivot 88 is contemplated to permit only rotation of the vane 84 with respect to the closure 86 between the installation configuration and the installed configuration. However, the present invention is not limited solely to such a construction. In an alternative, it is contemplated that the pivot 88 may be constructed as a ball joint (or an equivalent type of joint) that permits an angle between the vane 84 and the closure 86 to be adjusted in addition to permitting rotation of the vane 84 and the closure 86 with respect to one another.

In the embodiment of the air deflector 80, the vane 84 is illustrated with a generally trapezoidal shape. This shape is contemplated to compliment the interior surfaces of the air plenum 60, 62 illustrated in FIG. 2. Specifically, the vane 84 is contemplated to engage the interior surfaces of the air plenum 60, 62 and, thereby, to close off at least a portion of the air plenum 60, 62 to alter the flow of air therethrough. The vane 84, however, should not be understood to be limited to this shape. The vane 84 may take any shape including, but not limited to triangular, square, rectangular, trapezoidal, polygonal, circular, elliptical, oval, and/or amorphous.

In addition, the vane 84 is illustrated with a uniform thickness 118 from the vane first side 102 to the vane second side 106. However, a uniform thickness 118 is not required for the vane 84. In alternative embodiments, the thickness 118 may vary from the vane first side 102 to the vane second side 106. In one specific contemplated embodiment, for example, the thickness 118 may decrease, in a tapered manner, from the first vane side 102 to the second vane side 106.

As also illustrated in FIG. 5, the vane 84 is contemplated to present a solid barrier to the flow of air within the plenum 62. As such, the vane 84 is constructed as a solid piece of material.

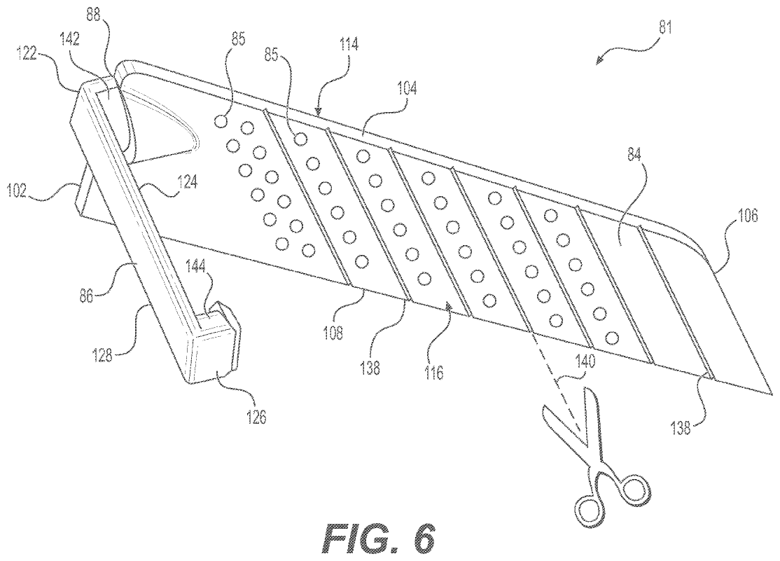

In an alternate embodiment of the air deflector 81 that is shown in FIG. 6, the vane 84 includes perforations 85 therethrough. The perforations 85 permit air to pass through the vane 84. In this embodiment, the vane 84 retards, but does not close off, the interior of the air plenum 60, 62.

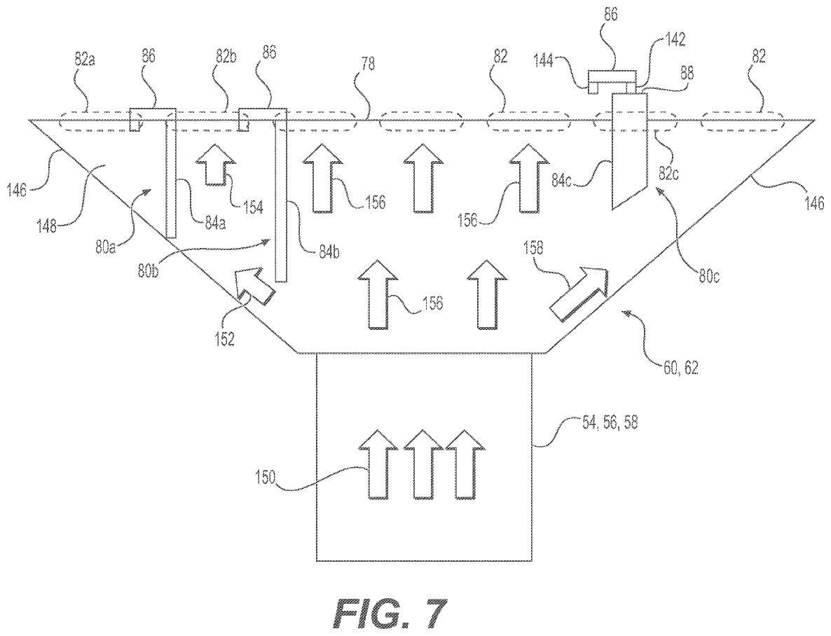

For the embodiments of the air deflectors 80, 81 illustrated in FIGS. 5 and 6, the vane 84 also may be provided with a plurality of cut lines 138 to facilitate shaping of the vane 84 along, for example, a scissor line 140. With this configuration, it is contemplated that a singular embodiment of the vane 84 may be shaped for any particular location within the plenum 60, 62. This feature is more clearly illustrated in FIG. 7. It is noted that the vane 84 may be shaped by reducing the vane height 112 in addition to reducing the vane length 110.

In connection with this embodiment, it is contemplated that the air deflectors 80, 81, will exclude cut lines 138. In particular, it is contemplated that the air deflectors 80, 81 will be sized for the plenum 60, 62 in which the air deflector 80, 81 is positioned. As should be apparent to those skilled in the art, the air deflectors 80, 81 may be provided in any number of shapes and sizes as required or desired for placement into the plenum 60, 62.

In another contemplated embodiment, the air deflector 80, 81 may be constructed without a pivot 88. In this construction, the vane 84 remains fixed with respect to the closure 86. Here, the air deflector 80, 81 may be manufactured in a wide variety of pre-determined angular configurations. For example, as discussed below, the vane 84 may be fixed with respect to the closure 86 at an angle that includes, but is not limited to, 15, 30, 45, 90, 135, 150, and 165 degrees from the horizontal. And, as also described, other, fixed angles are contemplated to fall within the scope of the present invention.

FIG. 7 is a graphical, top view of the air plenum 60, 62 that is illustrated in FIG. 2. For reference, the locations of the openings 82 in the vent plate 78 are indicated by dotted lines.

As also illustrated in FIG. 4, the closure 86 straddles two adjacent openings 82. In particular, as illustrated in FIGS. 4 and 7, the closure 86 includes a first projection 142 at the closure first side 122 and a second projection 144 at the closure second side 126. The first projection 142 is configured to engage the opening second side 94 of one opening 82. The second projection 144 is configured to engage the opening first side 90 of the adjacent opening 82.

In the illustrated embodiment, the closure 86 is intended to be held in place by an interference fit between the edges of the two adjacent openings 82 and the first projection 142 and the second projection 144. While an interference fit is contemplated to be adequate, the closure 86 may be attached to the vent plate 78 by any other suitable fastener. For example, the closure 86 may be attached to the vent plate 78 via adhesives, screws, nuts and bolts, etc.

In an alternative embodiment, it is contemplated that the closure 86 may be configured to engage only one of the openings 82. For example, the first projection 142 may be configured to engage the opening first side 90 and the second projection 144 may be configured to engage the opening second side 94. Still other variations are contemplated to fall within the scope of the present invention.

As noted above, the closure 86 is contemplated to cover at least a portion of one or more of the openings 82. While the closure 86 is contemplated to present a solid barrier to the flow of air, it is contemplated that the closure 86 may include one or more perforations to permit air to flow through the closure 86.

With continued reference to FIG. 7, three air deflectors 80a, 80b, 80c are shown in connection with the air plenum 60, 62. A first air deflector 80a is affixed to the vent plate 78 so that the vane 84a extends from the vent plate 78 to the rear wall 146 of the air plenum 60, 62. The second air deflector 80b also is affixed to the vent plate 78. For this air deflector 80b, the vane 84b extends only part of the distance from the vent plate 78 to the rear wall 146 of the air plenum 60, 62. The third air deflector 80c is in the process of being installed and, therefore, is shown in the installation configuration. The air deflector 80c is illustrated in a position where a portion of the vane 84c extends into the air plenum 60, 62. Once completely inserted through the opening 82c, the vane 84c will be rotated to a vertical orientation, just like the vanes 84a, 84b, thereby being reconfigured to the installed configuration.

For clarity, in the illustrated embodiments, the interior cross-sections of the air plena 60, 62 are rectangular with a long axis in the horizontal direction and a short axis in the vertical direction. As also illustrated, the openings 82 are oriented such that the oblong axes of the openings 82 are horizontal. Therefore, the orientation of the vanes 84 in a vertical direction is intended to convey that the vanes 84, when in the vertical orientation, are perpendicular to the horizontal orientation and, therefore, are contemplated to block air flow in the horizontal direction, at least in part.

While it is contemplated that the vanes 84 will be oriented vertically when installed, the present invention contemplates that the installed configuration of each vane 84 may be at any suitable angle with respect to the horizontal or vertical. Suitable angles include, but are not limited to, 15, 30, 45, 90, 135, 150, and 165 degrees from the horizontal. These angles are not intended to limit the present invention as any angle greater than 0 but less than 180 degrees may be employed to alter the air flow within the plena 60, 62. Similarly, each vane 84 may be oriented at a different angle from each other vane 84 without departing from the scope of the present invention.

In still another contemplated embodiment, the vane 84 and the closure 86 may be manufactured from a flexible material that permits the vane 84 to flex with respect to the closure 86 and, therefore, to facilitate installation of the air deflector 80.

As shown in FIG. 7, air flows through the duct 54, 56, 58 in a general direction as indicated by the arrows 150. Inside the air plenum 60, 62, the air flows along various paths, some of which are indicated by the arrows 152, 154, 156, 158. The air exits from the air plenum 60, 62 through the openings 82 in the vent plate 78.

In the discussion that follows, the vanes 84 are described in such a manner that the vanes 84 act as a complete barrier to the flow of air within the plenum 60, 62. The vanes 84 are described in this manner to simplify the discussion of the insertion and positioning of the vanes 84 according to one contemplated construction. As noted above, the present invention should not be understood to be limited to the disposition of vanes 84 in positions where air flow is completely blocked. It is not necessary to completely block the air flow to practice the present invention. To the contrary, the vanes 84 may only partially block the air flow within the plenum 60, 62. In one contemplated variation, the vane 84 may be shaped so that it only blocks a portion of the interior of the plenum 60, 62. In particular, it is contemplated that the height 112 of the vanes 84 will be less than the height within the air plenum 60, 62. In another contemplated embodiment, the vane 84 may be angled within the plenum 60, 62, as discussed above, thereby affecting the air flow only in part. Still further, the vane 84 may be shaped to be smaller than the interior of the air plenum 60, 62 and also to be angled, thereby altering the air flow without blocking the air flow. As should be apparent to those skilled in the art, there are innumerable variations for the shape and placement of the vanes 84 to alter some or all of the air flow within the plenum 60, 62. Those variations are contemplated to fall within the scope of the present invention.

With reference to the first air deflector 80a, the vane 84a extends to the rear wall 146 and contacts the rear wall 146. As such, in the illustrated embodiment, the air cannot flow pass the vane 84a into the area 148 adjacent thereto. Accordingly, the flow of air from the associated opening 82a is restricted and/or prevented. As should be apparent, this alters the flow of air from the air plenum 60, 62. Again, as noted above, it is not necessary to completely block the flow to the area 148. In such a case, the flow is contemplated to enter the area 148 through the gaps between the vane 84a and the top or bottom walls of plena 60, 62, because the height 112 of vane 84a is smaller than the height within the plena 60, 62. The gaps may be controlled by the height 112 of the vane 84a so that air flowing into the area 148 and air speed through the opening 82a may be reduced and/or adjusted.

The vane 84b of the second air deflector 80b extends only part of the distance to the rear wall 146. As such, the flow of air via along the path indicated by the arrows 152, 154 is contemplated to be diminished with respect to the flow of air within other areas inside of the air plenum 60, 62. A smaller flow of air, therefore, is contemplated to exit through the opening 82b by comparison with the remaining openings 82. Again, the air flow also may be controlled, for example, by angling the vane 80b.

As noted above, the air deflector 80c is shown in an orientation where the vane 84c is being inserted through the opening 82c. Here, the vane 84c is oriented about 90° from the position illustrated in FIG. 5, for example. In this orientation, the vane 84c easily passes through the opening 82c. After the closure 86 engages the vent plate 78, the vane 84c will be rotated to the position illustrated in FIGS. 5 and 6.

The various embodiments of the air deflector 80, 81 described above are contemplated to be made from a light-weight material such as plastic. However, the air deflector 80, 81 may be made from any suitable material including, but not limited to, a plastic, a resin, an elastomeric material, wood, paper, cellulose, a ceramic material, metal, aluminum, composite materials, carbon fiber composites, and the like. Still further, the air deflector 80, 81 may be constructed from a combination of materials deemed suitable for the operating environment. It is contemplated that, for an aircraft, the material used to construct the air deflector 80, 81 also will be subject to other parameters. For example, the material may need to be fire resistant.

The present invention also encompasses a system that combines the air plenum 60, 62, the vent plate 78, and one or more of the air deflectors 80, 81 discussed above. In particular, the present invention encompasses a system that permits local adjustment of the air flow through the air plenum 60, 62 as a result of the placement of one or more of the air deflectors 80, 81 through the openings 82 in the vent plate 78.

As discussed above, for the system of the present invention, the vent plate 78 is contemplated to include at least one opening 82 where the vane height 112 is less than the opening length 98. In addition, the vane thickness 118 is less than the opening height 100. When these parameters are satisfied, the vane 84 will be insertable through the opening 82 in the vent plate 78. As discussed, after insertion through the opening 82, the vane 84 may be rotated to a position where the vane 84 alters the air flow through the air plenum 60, 62.

In connection with the system, a number of relevant parameters are made apparent. For example, the vane height 112 is less than opening length 98. In addition, the vane thickness 118 is less than the opening height 100. This permits the vane 84 to be insertable through the opening 82. In addition, the vane height 112 is greater than the opening height 100. As a result, once the vane 84 is rotated from the installation configuration illustrated in FIG. 7 to the installed configuration illustrated in FIG. 5, the vane 84 cannot be removed from the opening 82. As a result, together with the attachment of the closure 86 in the opening(s) 82, the air deflector 80, 81 remains stably fixed to the vent plate 78 and within the air plenum 60, 62. Still further, the first projection 142 and the second projection 144 are dimensioned so that at least the closure height 132 is equal to or less than the opening height 100. This permits the closure 86 to engage the edges of the opening 82, inter alia, for an interference fit. Still other relationships between the various aspects of the present invention should be apparent to those skilled in the art.

As noted above, it is contemplated that the system permitting local adjustment of the air flow through the plenum 60, 62 will be positioned atop an overhead bin 36, 38 in the space between the overhead bin 36, 38 and the fuselage 12 of the aircraft. As should be apparent, the system does not need to be positioned in the gap between the overhead bin 36, 38 and the fuselage 12. The system may be disposed in an alternative location without departing from the scope of the present invention.

As indicated above, the present invention may be implemented in any of a number of configurations without departing from the scope thereof. Any and all equivalents and variations that should be apparent to those skilled in the art are intended to be encompassed by the present invention.

What is claimed is:

1. An air deflector, comprising:
a vane with a vane top, a vane bottom, a vane first side, and a vane second side, wherein the vane first side and the vane second side define a vane longitudinal axis extending therebetween; and
a closure with a closure top, a closure bottom, a closure first side, and a closure second side, wherein the closure first side and the closure second side define a closure longitudinal axis extending therebetween,
wherein the vane longitudinal axis intersects the closure longitudinal axis, and
wherein the vane is disposed at a predetermined angle with respect to the closure longitudinal axis.

2. The air deflector of claim 1, further comprising:
a pivot connecting the vane first side to the closure first side,
wherein the pivot permits the vane to rotate with respect to the closure.

3. The air deflector of claim 1, wherein the vane comprises:
a plurality of perforations therethrough.

4. The air deflector of claim 1, wherein the closure comprises:
a first projection extending from a closure first side; and
a second projection extending from a closure second side.

5. The air deflector of claim 2, wherein the closure comprises:
a first projection extending from a closure first side; and
a second projection extending from a closure second side, and
wherein the pivot connects the first projection to the vane first side.

6. The air deflector of claim 2, wherein the pivot comprises a ball joint that permits the vane to be angled with respect to the closure.

7. A system for adjusting an air flow within a cabin of an aircraft, comprising:
an air plenum;
a vent plate covering an outlet of the air plenum, wherein the vent plate defines a plurality of openings; and
at least one air deflector disposable, within the air plenum, through one of the plurality of openings,
wherein the at least one air deflector comprises
a vane with a vane top side, a vane bottom side, a vane first side, and a vane second side, wherein the vane first side and the vane second side define a vane longitudinal axis extending therebetween, and
a closure with a closure top side, a closure bottom side, a closure first side, and a closure second side, wherein the closure first side and the closure second side define a closure longitudinal axis extending therebetween,
wherein the vane longitudinal axis intersects the closure longitudinal axis, and
wherein the vane is disposed at a predetermined angle with respect to the closure longitudinal axis.

8. The system of claim 7, wherein the at least one air deflector further comprises:
a pivot connecting the vane first side to the closure first side,
wherein the pivot permits the vane to rotate with respect to the closure.

9. The system of claim 7, wherein:
the one of the plurality of openings has an opening top side, an opening bottom side, an opening first side, and an opening second side;
the one of the plurality of openings defines an opening length between the opening first side and the opening second side;
the one of the plurality of openings defines an opening height between the opening top side and the opening bottom side;
the vane further comprises a first surface and a second surface defining a vane thickness therebetween;
the vane defines a vane height between the vane top side and the vane bottom side; and
the vane height is less than the opening length.

10. The system of claim 9, wherein the vane thickness is less than the opening height.

11. The system of claim 9, wherein the vane height is greater than the opening height.

12. The system of claim 9, wherein:
the closure comprises a first protrusion extending from the closure first side and a second protrusion extending from the closure second side, and
the first protrusion and the second protrusion define a closure height.

13. The air deflector of claim 7, wherein the at least one air deflector further comprises:
a pivot connecting the vane first side to the closure first side,
wherein the pivot permits the vane to rotate with respect to the closure, and
wherein the pivot connects the first projection to the vane first side.

14. The system of claim 12, wherein the closure height is less than or equal to the opening height, permitting the first protrusion and the second protrusion to be insertable into at least the one of the plurality of openings.

15. The system of claim 12, wherein the first protrusion is insertable into a first of the plurality of openings and the second protrusion is insertable into a second of the plurality of openings adjacent to the first of the plurality of openings.

16. The system of claim 7, wherein the vane comprises:
a plurality of perforations therethrough.

17. The system of claim 8, wherein the pivot comprises a ball joint permits the vane to be angled with respect to the closure.

18. The system of claim 17, wherein:
the vane has an installation configuration permitting the vane to be inserted through the one of the plurality of openings, and
the vane has an installed configuration where the vane is rotated within the air plenum.

19. The system of claim 18, wherein at least one gap separates the vane from the air plenum.

20. The system of claim 18, wherein the air plenum comprises a rear wall and the vane extends at least a portion of a distance from the vent plate to the rear wall.
